(19) United States
(12) Patent Application Publication
(10) Pub. No.: US 2013/0287224 A1
(43) Pub. Date: Oct. 31, 2013

(54) NOISE SUPPRESSION BASED ON CORRELATION OF SOUND IN A MICROPHONE ARRAY

(71) Applicants: Martin Nystrom, Horja (SE); Jesper Nilsson, Lund (SE); Sead Smailagic, Lund (SE)

(72) Inventors: Martin Nystrom, Horja (SE); Jesper Nilsson, Lund (SE); Sead Smailagic, Lund (SE)

(73) Assignee: SONY ERICSSON MOBILE COMMUNICATIONS AB, Lund (SE)

(21) Appl. No.: 13/824,046

(22) PCT Filed: Apr. 27, 2012
(86) PCT No.: PCT/IB12/52141

§ 371 Date: Mar. 15, 2013

(51) Int. Cl. H04R 3/00

(52) U.S. Cl. CPC H04R 3/005
USPC 381/92

(57) ABSTRACT

A microphone array includes a left microphone, a right microphone and a processor to receive a right microphone signal from the right microphone and a left microphone signal from the left microphone. The processor determines a timing difference between the left microphone signal and the right microphone signal. The processor determines whether the timing difference is within a time threshold. The processor time shifts one of the left microphone signal and the right microphone signal based on the timing difference. The processor also sums the shifted microphone signal and the other microphone signal to form an output signal.

### TECHNICAL FIELD OF THE INVENTION

The invention relates generally to microphone arrays, more particularly, to suppressing noise in microphone arrays.

### DESCRIPTION OF RELATED ART

Microphones are acoustic energy to electric energy transducers, i.e., devices that convert sound into an electric signal. A microphone's directionality or polar pattern indicates how sensitive the microphone is to sounds incident at different angles to a central axis of the microphone. Noise suppression may be applied to microphones to reduce an effect of noise on sound detected from a particular direction and/or in a particular frequency range.

### SUMMARY

In one implementation, a computer-implemented method in a microphone array, the microphone array including a left microphone and a right microphone, may include receiving a right microphone signal from the right microphone, receiving a left microphone signal from the left microphone, determining a timing difference between the left microphone signal and the right microphone signal, determining whether the timing difference is within the time threshold, time shifting one of the left microphone signal and the right microphone signal based on the timing difference when the timing difference is within the time threshold, and summing the shifted microphone signal and the other microphone signal to form an output signal.

In addition, identifying an average sound pressure level for a predetermined time slot for each of the left microphone signal and the right microphone signal, and selecting one of the left microphone signal and the right microphone signal that has a lowest average sound pressure level as the output signal for the predetermined time slot.

In addition, determining whether an output signal for a preceding time slot is from a same microphone signal as the output signal for the predetermined time slot, identifying a zero crossing point near a border of the preceding time slot and the predetermined time slot when the output signal for a preceding time slot is not from the same microphone signal as the output signal for the predetermined time slot, and transitioning from the output signal for the preceding time slot to the output signal for the predetermined time slot based on the zero crossing point.

In addition, smoothing the transition to the one of the left microphone signal and the right microphone signal that has the lowest relative sound pressure level.

In addition, identifying whether the left microphone signal and the right microphone signal are consistent with a target sound type based on at least one of an amplitude response, a frequency response, and a timing for each of the left microphone signal and the right microphone signal.

In addition, identifying a sound pressure level associated with each of the left microphone and the right microphone, determining a correlation between the timing difference and the sound pressure level associated with each of the left microphone and the right microphone, and determining whether the correlation indicates that left microphone signal and the right microphone signal are based on speech from a target source.

In addition, the computer-implemented method may include dividing the left microphone signal and the right microphone into a plurality of frequency bands, identifying noise in at least one of the plurality of frequency bands, and filtering the noise in the at least one of the plurality of frequency bands.

In addition, the computer-implemented method may include filtering the noise in the at least one of the plurality of frequency bands may include selecting a polar pattern for filtering the noise in the at least one of the plurality of frequency bands based on a signal to noise ratio in each of the at least one of the plurality of frequency bands.

In addition, the computer-implemented method may include determining whether noise is present in the left microphone signal and the right microphone signal based on a comparison between an omnidirectional polar pattern and a very directed polar pattern associated with the dual microphone array.

In addition, the computer-implemented method may include selecting a transition angle for passing sound in the dual microphone array, and determining a value for the time threshold based on the selected transition angle.

In another implementation, a dual microphone array device may include a left microphone, a right microphone, a memory to store a plurality of instructions, and a processor configured to execute instructions in the memory to receive a right microphone signal from the right microphone, receive a left microphone signal from the left microphone, determine a timing difference between the left microphone signal and the right microphone signal, determine whether the timing difference is within a time threshold, time shift at least one of the left microphone signal and the right microphone signal based on the timing difference when the timing difference is within the time threshold, and sum the shifted microphone signal and the other microphone signal to form an output signal.

In addition, the processor is further to identify an average sound pressure level for a predetermined time slot for each of the left microphone signal and the right microphone signal, and select one of the left microphone signal and the right microphone signal that has a lowest average sound pressure level as the output signal for the predetermined time slot.

In addition, the processor is further to divide the left microphone signal and the right microphone into a plurality of frequency bands, identify noise in at least one of the plurality of frequency bands, and filter the noise in the at least one of the plurality of frequency bands.

In addition, the processor is further to determine whether an output signal for a preceding time slot is from a same microphone signal as the output signal for the predetermined time slot, identify a zero crossing point near a border of the preceding time slot and the predetermined time slot when the output signal for a preceding time slot is not from the same microphone signal as the output signal for the predetermined time slot, and transition from the output signal for the preceding time slot to the output signal for the predetermined time slot based on the zero crossing point.

In addition, the dual microphone array device may further include a vibrational sensor, and the processor is further to identify user speech based on an input provided by the vibrational sensor, and select a polar pattern based on a current occurrence of user speech.

In addition, the dual microphone array device may further include a positioning element to hold each of the left microphone and the right microphone on the torso of a user at approximately equal distances from a mouth of the user in a forward facing position.

In addition, the processor is further to identify whether the left microphone signal and the right microphone signal are consistent with speech from the target source based on at least one of an amplitude response, a frequency response, and a timing for each of the left microphone signal and the right microphone signal.

In addition, the processor is further to identify a sound pressure level associated with each of the left microphone and the right microphone, determine whether a correlation between the timing difference and the sound pressure level associated with each of the left microphone and the right microphone, and determine whether the correlation indicates that left microphone signal and the right microphone signal are based on speech from a target source.

In addition, when filtering the noise in the at least one of the plurality of frequency bands, the processor is further to select a polar pattern for filtering the noise in the at least one of the plurality of frequency bands based on a signal to noise ratio in each of the at least one of the plurality of frequency bands, and to select the polar pattern from a group including an omnidirectional polar pattern, a figure eight polar pattern, and a frequency independent polar pattern.

In yet another implementation, a computer-readable medium includes instructions to be executed by a processor associated with a microphone array, the microphone array including a left microphone and a aright microphone, the instructions including one or more instructions, when executed by the processor, for causing the processor to receive a right microphone signal from the right microphone, receive a left microphone signal from the left microphone, determine a timing difference between the left microphone signal and the right microphone signal, determine whether the timing difference is within a time threshold, time shift one of the left microphone signal and the right microphone signal to a time of the other of the left microphone signal and the right microphone signal based on the timing difference, and sum the shifted microphone signal and the other microphone signal to form an output signal.

### BRIEF DESCRIPTION OF THE DRAWINGS

The accompanying drawings, which are incorporated in and constitute part of this specification, illustrate one or more embodiments described herein and, together with the description, explain the embodiments. In the drawings:

FIGS. 1A and 1B illustrate, respectively, an exemplary dual microphone array and the exemplary dual microphone array positioned with respect to a user consistent with embodiments described herein;

FIG. 2 is a block diagram of exemplary components of a device of FIGS. 1A-1B;

FIGS. 3A, 3B, and 3C illustrate relative positions of a left and right microphone with respect to a sound source and an associated relationship between time and sound pressure levels (SPLs) consistent with embodiments described herein;

FIGS. 4A and 4B illustrate, respectively, a timing difference for unsymmetrically placed sound source and an associated non symmetrical dipole polar pattern;

FIG. 5 illustrates a dipole polar pattern for a frequency independent implementation of a microphone array consistent with embodiments described herein;

FIG. 6 illustrates exemplary frequency band filtering consistent with embodiments described herein;

FIGS. 7A, 7B, 7C and 7D illustrate noise suppression based on a lowest relative SPL detected in a right microphone or a left microphone of a dual microphone array consistent with embodiments described herein; and

FIG. 8 is a flow diagram of an exemplary process of suppressing noise in a dual microphone array consistent with implementations described herein.

### DETAILED DESCRIPTION

The following detailed description refers to the accompanying drawings. The same reference numbers in different drawings may identify the same or similar elements. Also, the following detailed description is exemplary and explanatory only and is not restrictive of the invention, as claimed.

Embodiments described herein relate to devices, methods, and systems for suppressing noise in a dual microphone array. Methods included herein may utilize correlation between two neck mounted microphones for suppression of noise, such as scratch noise, wind noise, and surrounding audio noise, in a voice based microphone application.

Consistent with embodiments described herein, noise suppression in a dual microphone array may be implemented based on correlation between the microphones. Alternatively, consistent with embodiments described herein, noise suppression in the dual microphone array may be achieved using filtering of the frequency bands.

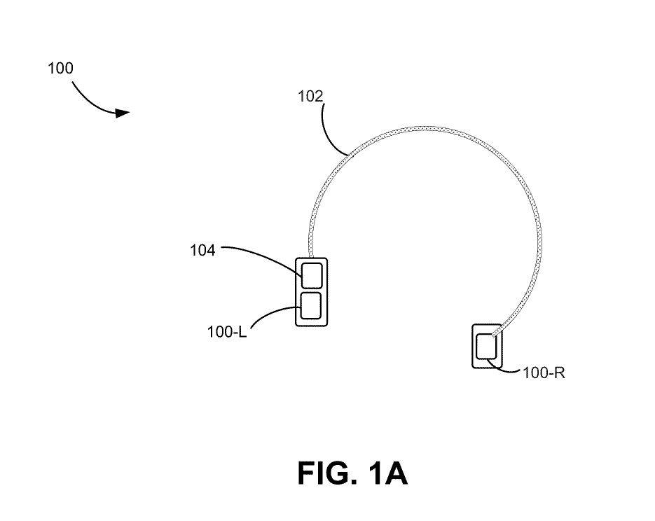

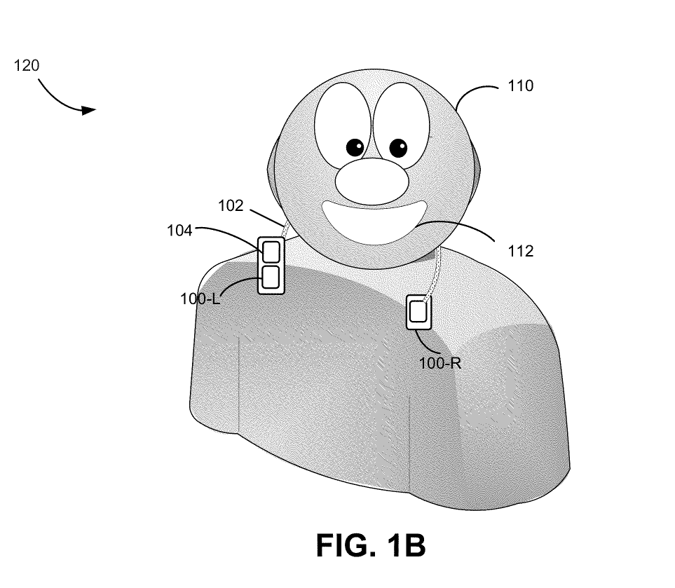

FIG. 1A illustrates an exemplary dual microphone array 100 consistent with embodiments described herein. Dual microphone array 100 may include a left microphone 100-L and a right microphone 100-R. Left microphone and right microphone 100-R may be connected by a wire/support 102. Dual microphone array 100 may also include a microcontroller unit (MCU) 104 that interfaces with microphones 100-L and 100-R. The configuration of components of dual microphone array 100 illustrated in FIG. 1 is for illustrative purposes only. Although not shown, dual microphone array 100 may include additional, fewer and/or different components than those depicted in FIG. 1. Dual microphone array 100 may also include other components of a dual microphone array 100 and/or other configurations may be implemented. For example, dual microphone array 100 may include one or more network interfaces, such as interfaces for receiving and sending information from/to other devices, one or more processors, etc.

FIG. 1B illustrates dual microphone array 100 positioned for operation on a user 110. Left microphone 100-L and right microphone 100-R are positioned to receive sound that originates from mouth 112 of user 110. For example, left microphone 100-L may be positioned to the left of mouth 112 and right microphone 100-R may be positioned to the right of mouth 112. Left microphone 100-L and right microphone 100-R are positioned with approximate mirror symmetry with respect to each other across a transverse plane of (the body of) user 110. For example, left microphone 100-L may be positioned on the upper left chest (or clavicle) of user 110 and right microphone 100-R may be positioned on the upper right chest of user 110. Both microphones 100-L-R may be maintained in position by an associated pinning mechanism (not shown) (e.g., a pin, button, Velcro, etc.), or by wire/support 102 for instance resting on the neck of user 110.

In implementations described herein, dual microphone array 100 may utilize correlation between sound detected at left microphone 100-L and right microphone 100-R to implement suppression of noise, such as scratch noise, wind noise, and surrounding audio noise, in sounds received by dual microphone array 100.

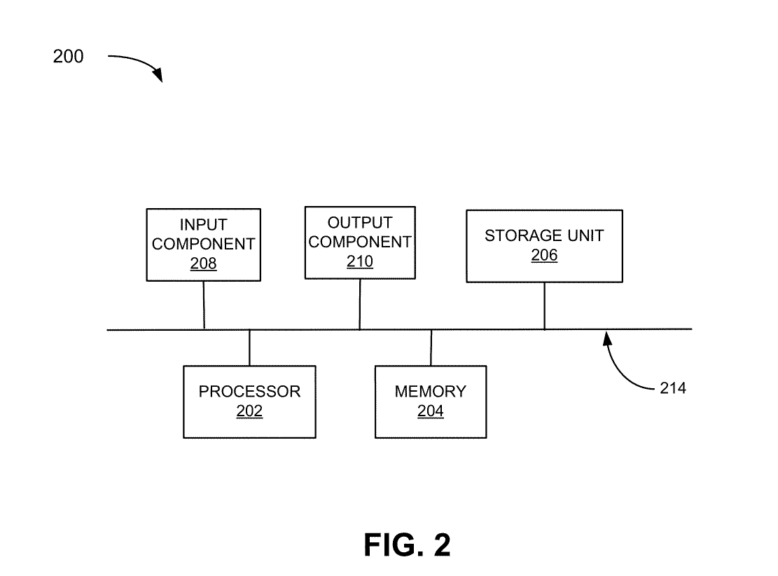

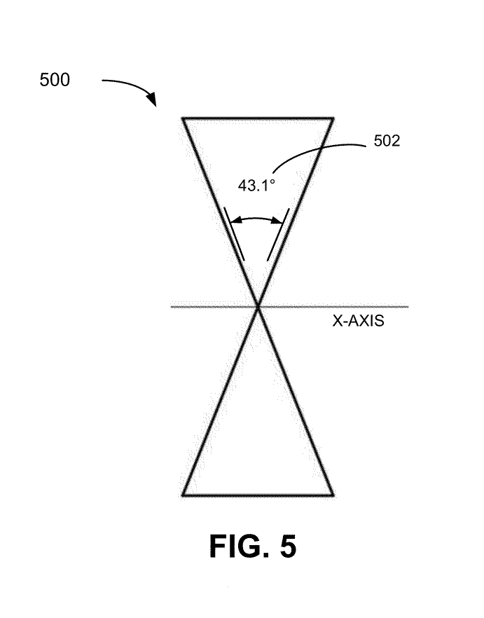

FIG. 2 is a block diagram of exemplary components of device 200. Device 200 may represent any one of dual microphone array 100, and/or components of the microphone array, such as MCU 104. As shown in FIG. 5, device 200 may include a processor 202, memory 204, storage unit 206, input component 208, output component 210, and communication path 214.

Processor 202 may include a processor, a microprocessor, an Application Specific Integrated Circuit (ASIC), a Field Programmable Gate Array (FPGA), and/or other processing logic (e.g., audio/video processor) capable of processing information and/or controlling device 200.

Memory 204 may include static memory, such as read only memory (ROM), and/or dynamic memory, such as random access memory (RAM), or onboard cache, for storing data and machine-readable instructions. Storage unit 206 may include a magnetic and/or optical storage/recording medium. In some implementations, storage unit 206 may be mounted under a directory tree or mapped to a drive.

Input component 208 and output component 210 may include a display screen, a keyboard, a mouse, a speaker, a microphone, a Digital Video Disk (DVD) writer, a DVD reader, Universal Serial Bus (USB) port, and/or other types of components for converting physical events or phenomena to and/or from digital signals that pertain to device 200. Communication path 214 may provide an interface through which components of device 200 can communicate with one another.

In different implementations, device 200 may include additional, fewer, or different components than the ones illustrated in FIG. 2. For example, device 200 may include one or more network interfaces, such as interfaces for receiving and sending information from/to other devices. In another example, device 200 may include an operating system, applications, device drivers, graphical user interface components, communication software, digital sound processor (DSP) components, etc.

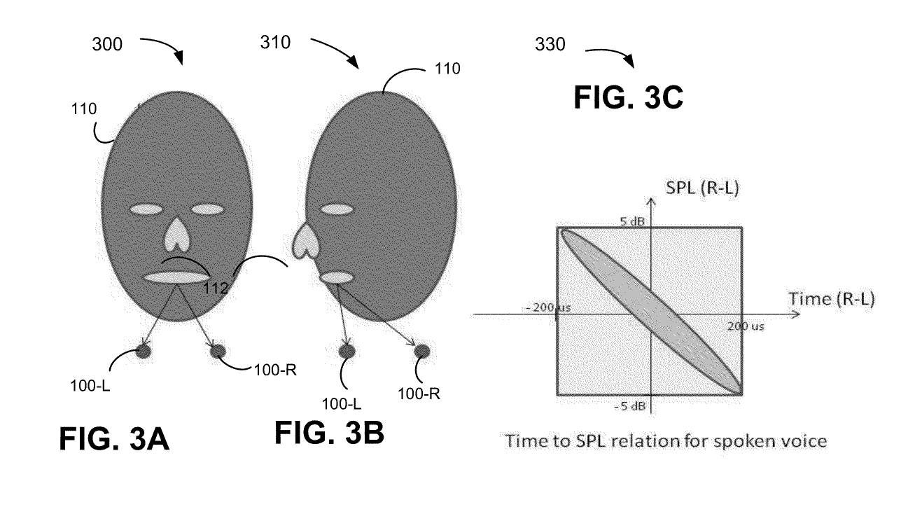

FIGS. 3A-3C illustrate relative positions of left microphone 100-L and right microphone 100-R with respect to a sound source (mouth 112) and an associated relationship between time and sound pressure level (SPL) for sound received at left microphone 100-L and right microphone 100-R. FIG. 3A illustrates left microphone 100-L and right microphone 100-R positioned at an equal distance from mouth 112. FIG. 3B illustrates left microphone 100-L and right microphone 100-R positioned at different distances from mouth 112. FIG. 3C shows an associated relative SPL based on a timing difference between left microphone 100-L and right microphone 100-R.

As shown in FIG. 3A, left microphone 100-L and right microphone 100-R may be positioned at equal distances from mouth 112. In this instance, a sound from a target source (i.e., speech coming from mouth 112) that arrives at left microphone 100-L and at right microphone 100-R will have very similar timing, amplitude and frequency response detected at left microphone 100-L and at right microphone 100-R respectively. When user 110 positions mouth 112 straight forward, the sound may arrive at both microphones 100-L-R simultaneously and with similar SPL because both travel paths for sound to the respective microphones 100-L-R are approximately equal.

As shown in FIG. 3B, when user 110 turns their head, in this instance to the right, the path to right microphone 100-R is shorter than the path to left microphone 100-L. The timing difference for sound to travel to right microphone 100-R minus a timing difference for left microphone 100-L will be negative, since the sound arrives at right microphone 100-R first. The path length that a sound travels is proportional to the SPL. The SPL will decrease in proportion to radius² for a sound source with a spherical spreading pattern. In other words, if the sound arrives at right microphone 100-R first, the sound is also expected to be louder (i.e., higher SPL) in right microphone 100-R.

As shown in FIG. 3C, sound (represented by SPLs, shown on the vertical axis), has a linear relationship with distance and, accordingly, with time (as shown on the horizontal axis). Mouth 112 may be analyzed as a spherical source for a large part (e.g., based on frequency bands) of the spoken voice. Accordingly, for variations of head rotation/position and the received signals in the microphones, there is a strong correlation between timing difference and difference in SPL. With respect to sound from mouth 112, the difference in distance between mouth 112 to left microphone 100-L and mouth 112 to right microphone 100-R has a linear relationship to the difference in time for the sound to travel from mouth 112 to left microphone 100-L and the time that sound travels from mouth 112 to right microphone 100-R.

For sounds coming from the side of user 110, left microphone 100-L and right microphone 100-R may have different timing (i.e., timing difference detected at respective microphones 100-L-R), and, for many sounds, also different amplitude and frequency responses. Scratch noise and wind noise are by nature uncorrelated in the respective microphones 100-L-R. These differences may be used to suppress sounds coming from the side compared to sounds coming from mouth 112. The spoken voice (from mouth 112) may be identified based on sounds arriving within a window of time at respective microphones 100-L-R and a corresponding correlation between SPL detected at the respective microphones 100-L-R.

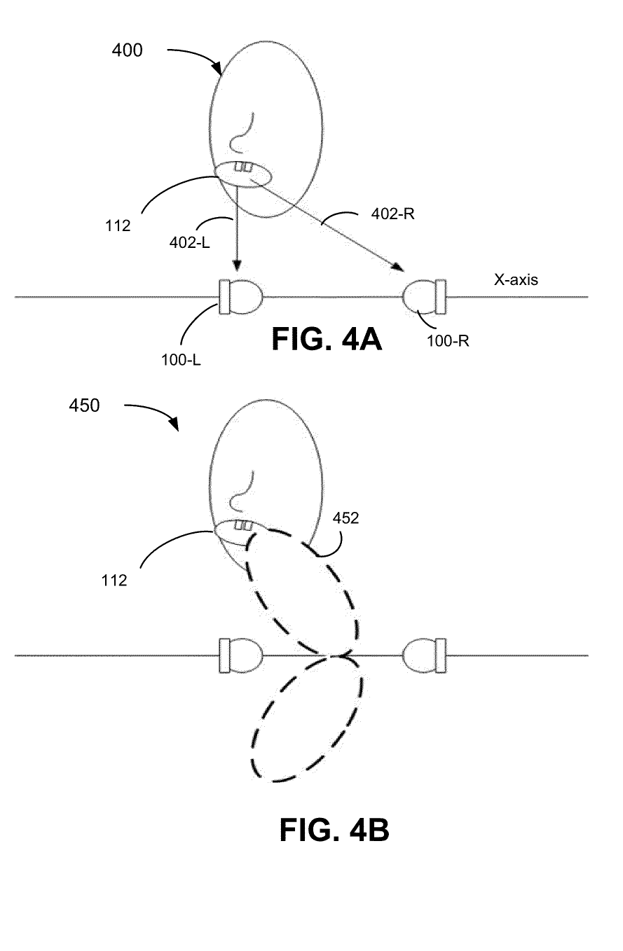

FIGS. 4A and 4B illustrate a relationship between a timing difference from left microphone 100-L and right microphone 100-R to an unsymmetrically placed sound source, in this instance mouth 112 (shown in diagram 400, FIG. 4A), and a resulting dipole polar pattern (shown in diagram 450, FIG. 4B).

As shown in FIG. 4A, mouth 112 is positioned at unequal (i.e., unsymmetrical) distances (402-L and 402-R respectively) from left microphone 100-L and right microphone 100-R. There will be a timing difference between left microphone 100-L and right microphone 100-R for spoken voice from mouth 112 that is approximately proportional to the difference in distances (i.e., 402-L minus 402-R) between left microphone 100-L and right microphone 100-R and mouth 112.

With respect to FIG. 4B, the timing difference between left microphone 100-L and right microphone 100-R, a time adjusted dipole polar pattern 452, arises when user 110 turns her/his head (and accordingly their mouth 112) sideways. A microphone polar pattern indicates the sensitivity of dual microphone array 100 to sounds incident at different angles to a central axis of left microphone 100-L and right microphone 100-R. Time adjusted dipole polar pattern 452 may be an unsymmetrical dipole polar pattern based on the adjusted timing difference between left microphone 100-L and right microphone 100-R. For example, the signal received at left microphone 100-L may be adjusted based on the timing differences between when signals are received from mouth 112 at each microphone 100-L-R and combined with the signal received at right microphone 100-R.

Time adjusted dipole polar pattern 452 may be a spatial pattern of sensitivity to sound that is directed towards mouth 112 of the user 110. Sound which originates from sources other than mouth 112, such as sources outside of time adjusted dipole polar pattern 452, may be considered noise and (because the noise falls outside of the time adjusted dipole polar pattern 452) are suppressed. Time adjusted dipole polar pattern 452 may be continuously updated based on a current timing difference. For example, time adjusted dipole polar pattern 452 may be adjusted based on the timing difference in instances in which user 110 positions one of microphone 100-L-R close to mouth 112 and maintains the other microphone at a position further away from mouth 112.

According to an embodiment, time adjusted dipole polar pattern 452 may also be adjusted based on input received from a vibrational sensor (not shown) associated with dual microphone array 100 (i.e., a sensor that detects vibrations generated by bone conducted speech). Dual microphone array 100 may use the detected vibration as an input to identify instances in which user 110 is speaking Time adjusted dipole polar pattern 452 may be activated (i.e., sound may be passed/allowed) based on whether user 110 has been identified as currently speaking. If the user is not speaking sound may be suppressed/blocked.

FIG. 5 illustrates a frequency independent dipole polar pattern 500. Dipole polar pattern 500 may result from adjusting a threshold for a timing correlation between the output signals from left microphone 100-L and right microphone 100-R and summing the adjusted output signals. Dipole polar pattern 500 is described with respect to FIGS. 4A and 4B by way of example.

A timing difference between sound received at left microphone 100-L and right microphone 100-R is independent of phase of the sound (i.e., sound from mouth 112 travels at a constant velocity regardless of phase). Accordingly, by adjusting the timing difference between output signals from left microphone 100-L and right microphone 100-R, dipole polar pattern 500 may be determined independent of frequency. In contrast to frequency dependent polar patterns (not shown), in which a full signal may be detected for in-phase sounds, and a lower signal for out-of-phase signals, dipole polar pattern 500 detect sounds, regardless of phase, in a particular direction. Dipole polar pattern 500 may provide improved directivity when compared to other dipole polar patterns.

According to one embodiment, dipole polar pattern 500 may be determined based on a predetermined threshold for timing correlation. The units for the predetermined threshold are time, in the scale of hundreds of micro seconds for an implementation such as shown in FIG. 1B. For example, a timing difference between left microphone 100-L and right microphone 100-R may be determined from sample sequences. If the timing difference is less than the predetermined threshold, the sample may be added to the output signal, but if the timing difference is greater than the predetermined threshold, these samples may be ignored or discarded. Scratch and wind noise in the two microphones may be suppressed because the scratch noise and wind noise are uncorrelated, e.g., sounds arriving at one microphone (e.g., left microphone 100-L) and at a significantly later time (i.e., outside of the predetermined threshold) may be suppressed by dual microphone array 100.

The size of the predetermined threshold determines an opening angle 502 (shown as 43.1 degrees) in dipole polar pattern 500. A large predetermined threshold (i.e., a large timing difference) gives a large opening angle 502 and a small threshold gives a small opening angle 502 in dipole polar pattern 500. For example, a sound may be a limited sequence of samples (e.g., 220 consecutive samples at a sample frequency of 44 kHz correspond to a sound with a duration of 5 milliseconds) from both left microphone 100-L and right microphone 100-R. Left microphone 100-L and right microphone 100-R may be 78 mm apart. At 44 kHz sampling rate, each sample is about 7.8 mm long. A threshold timing window of +/−5 samples (equal to +/−0.1 milliseconds), may correspond to an opening angle 502 of +/−30 degrees (i.e. 60 degrees total) in dipole polar pattern 500.

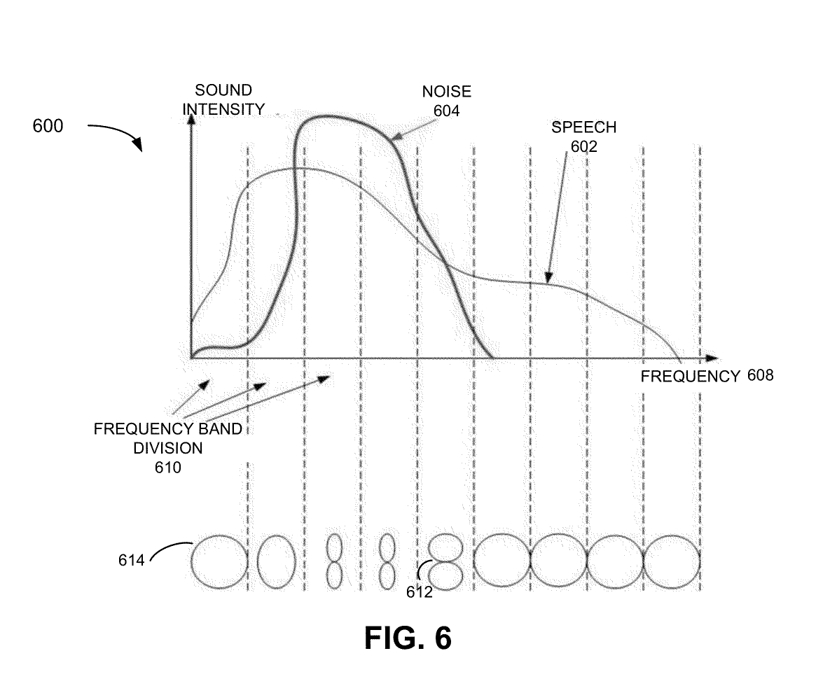

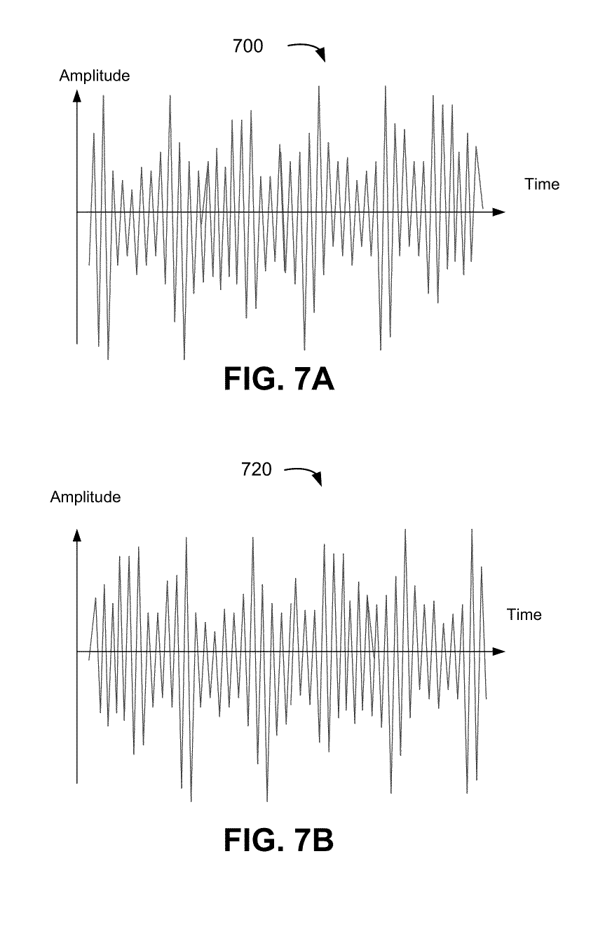

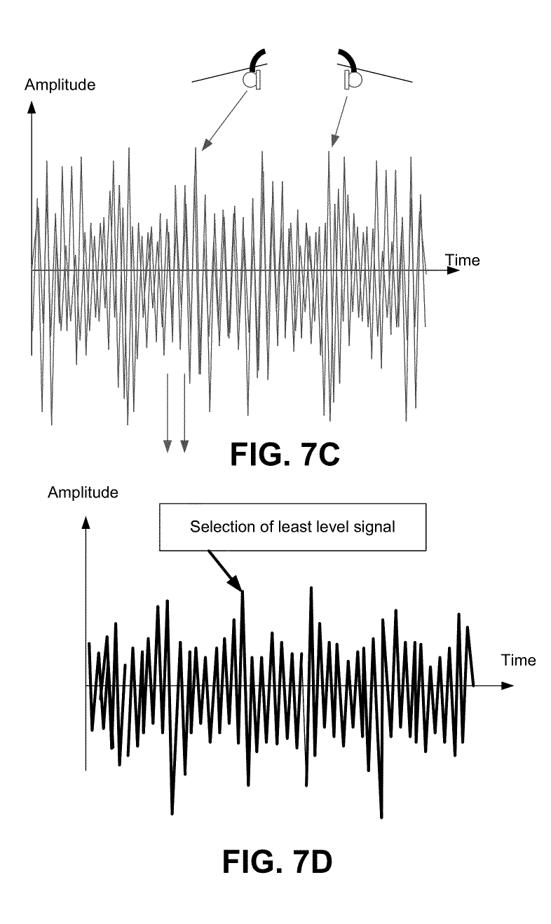

According to another embodiment, a scale factor may be set between timing and suppression of sounds. This scale factor may be selected to provide a selectable transition angle between suppression and passing of sound based on particular requirements. Further filtering may be applied to improve the performance compared to the summed output of left microphone 100-L and right microphone 100-R, for instance as described with respect to FIGS. 6 and 7A-7D.

FIG. 6 illustrates sound filtering diagram 600. Sound filtering diagram 600 includes speech 602, and noise 604, which are measured on a vertical axis of sound intensity 606 and a horizontal axis of frequency 608. Frequency 608 is divided into a plurality of frequency bands 610.

As shown in FIG. 6, sound received at left microphone 100-L and right microphone 100-R may be filtered by selecting adapted polar patterns based on signal to noise ratio detected in particular frequency bands 610. A signal may be extracted from sounds correlated in multiple frequency bands 610, after beam forming based on selected polar patterns in each of frequency bands 610. A beam is an area within which sound may be allowed to pass. The noise level in each band may be estimated, and used to set values for beam forming. Different polar patterns may be selected to produce narrower beams in bands in which noise 604 is relatively high (e.g., figure eight polar pattern 612) and broader beams (e.g., omnidirectional polar pattern 614) in frequency bands in which noise 604 is relatively low or not detected.

According to one implementation, a figure eight polar pattern 612 (e.g., half a wavelength between the microphones) may be selected for particular frequencies to form a beam that allows sound to be included in a microphone signal. Figure eight polar pattern 612 has a directivity index of 2 in the plane, and of 4 in the space. In other words, of surrounding noise coming from all directions, only noise that originates from a particular 25% of the directions may be detected/received (i.e., noise may only pass the dipole figure of eight from 25% of possible directions), while the sounds from mouth 112 may be unaffected because these are within the figure eight polar pattern 612.

FIGS. 7A-7D illustrate noise suppression based on a lowest relative SPL detected in a right microphone 100-R or a left microphone 100-L of a dual microphone array 100.

When user 110 is speaking, the voice signal is present in both microphones 100-L-R simultaneously. FIG. 7A shows a voice signal received at right microphone 100-R. FIG. 7B shows the voice signal received at left microphone 100-L. The voice signal in right microphone 100-R and left microphone 100-L is correlated. However, noise from scratch and wind are uncorrelated and may be present in one microphone (e.g. right microphone 100-R) independently of presence in the other microphone (e.g., left microphone 100-L) at a particular instant. The voice signals from right microphone 100-R and left microphone 100-L may be summed as shown in FIG. 7C. However, when voice and noise are summed together in one microphone, the SPL may be higher compared to if no noise is present in the microphone.

The levels of the signals from the two microphones may be integrated over a selected time slot. As shown in FIG. 7D, for each time slot, the output is selected from the microphone with the lowest level in that time slot. If the levels in the microphones are much different, the difference may be attributed to wind and/or scratch noise in the microphone with the highest level. The microphone with the lowest signal may correspond to a lower level of noise.

According to an implementation, the transition between microphone signals (i.e., from one microphone signal to the other microphone signal when the relative noise switches) may be performed at “zero crossing”, i.e. when the levels are low. If there is a difference between the signals in the transition from one microphone to the other, smoothing may also be applied.

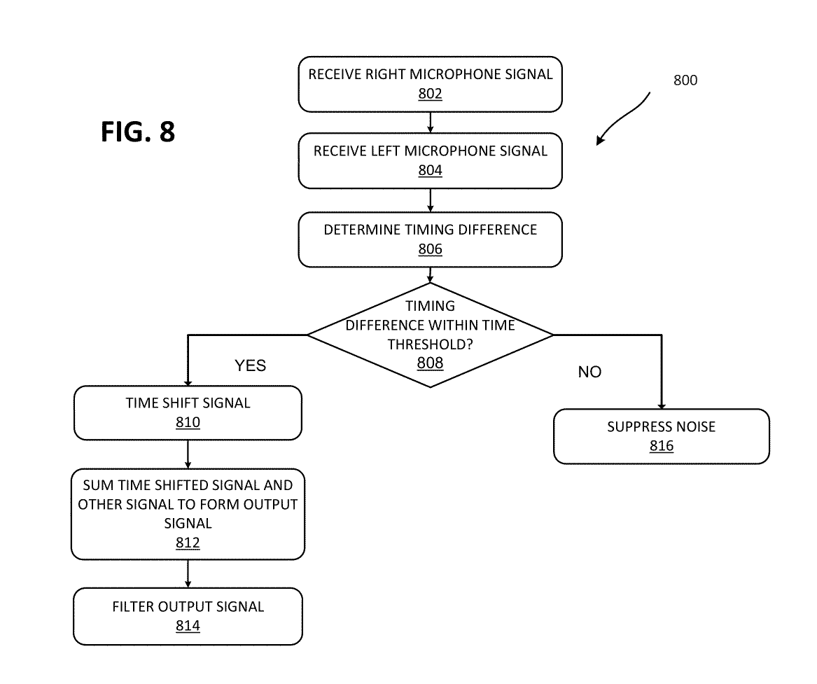

FIG. 8 is a flowchart of an exemplary process 800 for using correlation between sounds received at each microphone in a dual microphone array to suppress noise in a manner consistent with implementations described herein. Process 800 may execute in a MCU 104 that is incorporated or integrated into a dual microphone array 100. It should be apparent that the process discussed below with respect to FIG. 8 represents a generalized illustration and that other elements may be added or existing elements may be removed, modified or rearranged without departing from the scope of process 800.

MCU 104 may receive a right microphone signal from a right microphone 100-R (block 802). For example, right microphone 100-R, may receive sound from one or both of mouth 112 or extraneous noise, such as wind noise or scratch noise. MCU 104 may store right microphone signal in a right microphone buffer (not shown).

MCU 104 may receive a left microphone signal from a left microphone 100-L (block 804). MCU 104 may store left microphone signal in a left microphone buffer (not shown).

MCU 104 may determine a timing difference between left microphone signal and right microphone signal (block 806). For example, MCU 104 may determine whether left microphone signal is received within a particular number of sound samples (and accordingly within a particular time) after right microphone signal (i.e., the sound arrives at each of right microphone 100-R and left microphone 100-L at approximately the same time). MCU 104 may subtract the time that left microphone signal is received from the time that the corresponding right microphone signal is received.

MCU 104 may determine whether the timing difference is within a time threshold (block 808), such as described above with respect to FIG. 5 and frequency independent dipole polar pattern 500.

At block 810, MCU 104 may time shift one of left microphone signal and right microphone signal based on the timing difference when the timing difference is within the time threshold (block 808=yes). MCU 104 may sum the shifted microphone signal and the other microphone signal to form an output signal (block 812).

MCU 104 may also filter the signals, for instance as described with respect to FIGS. 7A-7D (block 814). MCU 104 may also apply filtering in different frequency bands, such as described with respect to FIG. 6.

According to another implementation, the microphone signals may be filtered using frequency and/or amplitude correlation to sort out and suppress noise sources. MCU 104 may pass (i.e., allow) sounds with high correlation in amplitude and/or frequency to pass (i.e., MCU 104 may attribute sounds that fulfill these criteria as sounds from mouth 112). MCU 104 may suppress (or discard) sounds that do not fulfill the required criteria, such as sounds with different amplitude (e.g. sounds that may come from a person speaking nearby). The intensity of a voice from someone nearby (e.g., someone speaking over user 110's shoulder) will decrease with distance, and may give different amplitude in the two microphones.

At block 816, MCU 104 may suppress noise in dual microphone array 100 when the timing difference is not within the time threshold (block 808=no). For example, MCU 104 may discard uncorrelated sounds arriving at one microphone (e.g., left microphone 100-L) and at a time greater than the time threshold.

As described above, process 800 may occur continuously as sound is detected by right microphone 100-R and left microphone 100-L.

The foregoing description of implementations provides illustration, but is not intended to be exhaustive or to limit the implementations to the precise form disclosed. Modifications and variations are possible in light of the above teachings or may be acquired from practice of the teachings. For example, the techniques described above can well be combined with known noise suppressing techniques used on single microphone. Additionally, although examples are described with respect to a dual microphone array, principles disclosed may be extended to a microphone array including more than two microphones.

In the above, while series of blocks have been described with regard to the exemplary processes, the order of the blocks may be modified in other implementations. In addition, non-dependent blocks may represent acts that can be performed in parallel to other blocks. Further, depending on the implementation of functional components, some of the blocks may be omitted from one or more processes.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

It should be emphasized that the term “comprises/comprising” when used in this specification is taken to specify the presence of stated features, integers, steps or components but does not preclude the presence or addition of one or more other features, integers, steps, components, or groups thereof.

Further, certain portions of the implementations have been described as “logic” that performs one or more functions. This logic may include hardware, such as a processor, a microprocessor, an application specific integrated circuit, or a field programmable gate array, software, or a combination of hardware and software.

No element, act, or instruction used in the present application should be construed as critical or essential to the implementations described herein unless explicitly described as such. Also, as used herein, the article “a” is intended to include one or more items. Further, the phrase “based on” is intended to mean “based, at least in part, on” unless explicitly stated otherwise.

What is claimed is:

1. A computer-implemented method in a microphone array, wherein the microphone array includes a left microphone and a right microphone, comprising:
receiving a right microphone signal from the right microphone;
receiving a left microphone signal from the left microphone;
determining a timing difference between the left microphone signal and the right microphone signal;
determining whether the timing difference is within a time threshold;
time shifting one of the left microphone signal and the right microphone signal based on the timing difference when the timing difference is within the time threshold; and
summing the shifted microphone signal and the other microphone signal to form an output signal.

2. The computer-implemented method of claim 1, further comprising:
identifying an average sound pressure level for a predetermined time slot for each of the left microphone signal and the right microphone signal;
selecting one of the left microphone signal and the right microphone signal that has a lowest average sound pressure level as the output signal for the predetermined time slot.

3. The computer-implemented method of claim 2, further comprising:
determining whether an output signal for a preceding time slot is from a same microphone signal as the output signal for the predetermined time slot;
identifying a zero crossing point near a border of the preceding time slot and the predetermined time slot when the output signal for a preceding time slot is not from the same microphone signal as the output signal for the predetermined time slot;
transitioning from the output signal for the preceding time slot to the output signal for the predetermined time slot based on the zero crossing point.

4. The computer-implemented method of claim 2, further comprising:
smoothing the transition to the one of the left microphone signal and the right microphone signal that has the lowest relative sound pressure level.

5. The computer-implemented method of claim 1, further comprising:
identifying whether the left microphone signal and the right microphone signal are consistent with a target sound type based on at least one of an amplitude response, a frequency response, or a timing for each of the left microphone signal and the right microphone signal.

6. The computer-implemented method of claim 1, further comprising:
identifying a sound pressure level associated with each of the left microphone and the right microphone;
determining a correlation between the timing difference and the sound pressure level associated with each of the left microphone and the right microphone; and
determining whether the correlation indicates that left microphone signal and the right microphone signal are based on speech from a target source.

7. The computer-implemented method of claim 1, further comprising:
dividing the left microphone signal and the right microphone into a plurality of frequency bands;
identifying noise in at least one of the plurality of frequency bands; and
filtering the noise in the at least one of the plurality of frequency bands.

8. The computer-implemented method of claim 7, wherein filtering the noise in the at least one of the plurality of frequency bands further comprises:
selecting a polar pattern for filtering the noise in the at least one of the plurality of frequency bands based on a signal to noise ratio in each of the at least one of the plurality of frequency bands.

9. The computer-implemented method of claim 1, further comprising:
determining whether noise is present in the left microphone signal and the right microphone signal based on a comparison between an omnidirectional polar pattern and a very directed polar pattern associated with the dual microphone array.

10. The computer-implemented method of claim 1, further comprising:
selecting a transition angle for passing sound in the dual microphone array; and
determining a value for the time threshold based on the selected transition angle.

11. A dual microphone array device, comprising:
a left microphone;
a right microphone;
a memory to store a plurality of instructions; and
a processor configured to execute instructions in the memory to:
receive a right microphone signal from the right microphone;
receive a left microphone signal from the left microphone;
determine a timing difference between the left microphone signal and the right microphone signal;
determine whether the timing difference is within a time threshold;
time shift at least one of the left microphone signal and the right microphone signal based on the timing difference when the timing difference is within the time threshold; and
sum the shifted microphone signal and the other microphone signal to form an output signal.

12. The dual microphone array of claim 11, wherein the processor is further configured to:
identify an average sound pressure level for a predetermined time slot for each of the left microphone signal and the right microphone signal; and
select one of the left microphone signal and the right microphone signal that has a lowest average sound pressure level as the output signal for the predetermined time slot.

13. The dual microphone array of claim 12, wherein the processor is further configured to:
determine whether an output signal for a preceding time slot is from a same microphone signal as the output signal for the predetermined time slot;
identify a zero crossing point near a border of the preceding time slot and the predetermined time slot when the output signal for a preceding time slot is not from the same microphone signal as the output signal for the predetermined time slot; and
transition from the output signal for the preceding time slot to the output signal for the predetermined time slot based on the zero crossing point.

14. The dual microphone array of claim 12, wherein the processor is further configured to:
divide the left microphone signal and the right microphone into a plurality of frequency bands;
identify noise in at least one of the plurality of frequency bands; and
filter the noise in the at least one of the plurality of frequency bands.

15. The dual microphone array of claim 11, further comprising a vibrational sensor, wherein the processor is further configured to:
identify user speech based on an input provided by the vibrational sensor; and
select a polar pattern based a current occurrence of user speech.

16. The dual microphone array of claim 11, further comprising:
a positioning element to hold each of the left microphone and the right microphone on the torso of a user at approximately equal distances from a mouth of the user in a forward facing position.

17. The dual microphone array of claim 11, wherein the processor is further configured to:
identify whether the left microphone signal and the right microphone signal are consistent with speech based on at least one of an amplitude response, a frequency response, or a timing for each of the left microphone signal and the right microphone signal.

18. The dual microphone array of claim 11, wherein the processor is further configured to:
identify a sound pressure level associated with each of the left microphone and the right microphone;
determine a correlation between the timing difference and the sound pressure level associated with each of the left microphone and the right microphone; and
determine whether the correlation indicates that left microphone signal and the right microphone signal are based on speech from a target source.

19. The dual microphone array of claim 18, wherein, when filtering the noise in the at least one of the plurality of frequency bands, the processor is further configured to:
select a polar pattern for filtering the noise in the at least one of the plurality of frequency bands based on a signal to noise ratio in each of the at least one of the plurality of frequency bands; and
wherein the processor is configured to select the polar pattern from a group including an omnidirectional polar pattern, a figure eight polar pattern, and a frequency independent polar pattern.

20. A computer-readable medium including instructions to be executed by a processor associated with a microphone array, wherein the microphone array includes a left microphone and a aright microphone, the instructions including one or more instructions, when executed by the processor, for causing the processor to:
receive a right microphone signal from the right microphone;
receive a left microphone signal from the left microphone;
determine a timing difference between the left microphone signal and the right microphone signal;
determine whether the timing difference is within a time threshold;
time shift one of the left microphone signal and the right microphone signal to a time of the other of the left microphone signal and the right microphone signal based on the timing difference; and
sum the shifted microphone signal and the other microphone signal to form an output signal.
